(19) United States
(12) Patent Application Publication
(10) Pub. No.: US 2015/0350385 A1
(43) Pub. Date: Dec. 3, 2015

(54) AGGREGATION OF DATA PACKETS FOR MULTIPLE STATIONS

(71) Applicant: QUALCOMM Incorporated, San Diego, CA (US)

(72) Inventors: Guido Robert FREDERIKS, Aptos, CA (US); James Simon CHO, Mountain View, CA (US)

(21) Appl. No.: 14/822,801

(22) Filed: Aug. 10, 2015

Related U.S. Application Data
(62) Division of application No. 14/015,725, filed on Aug. 30, 2013.

(51) Int. Cl. H04L 29/06; H04L 12/18; H04L 29/12

(52) U.S. Cl. CPC H04L 69/22; H04L 61/6004; H04L 12/18; H04W 84/12

(57) ABSTRACT

As one example, an apparatus for wireless communications includes a processing system configured to communicate with several receivers including a first receiver and a second receiver. The processing system is configured to generate an aggregate data packet including several data packets that include a first data packet and a second data packet. The first data packet is destined for the first receiver and the second data packet is destined for the second receiver. The aggregate data packet includes a delimiter that includes a group identifier for determining, at the first receiver, that at least one of the data packets, including the first data packet, is destined for the first receiver. The group identifier is also for determining, at the second receiver, that at least one of the data packets, including the second data packet, is destined for the second receiver.

### BACKGROUND

1. Field

The present disclosure relates generally to telecommunications, specifically to aggregate data packets directed to multiple stations.

2. Background

The deployment of wireless local area networks (WLANs) in the home, the office, and various public facilities is commonplace today. These networks typically employ a wireless access point (AP) that connects a number of wireless stations (STAs) in a specific locality (e.g., home, office, public facility, etc.) to another network, such as the Internet or the like.

In crowded WLANs optimal usage of the medium is desirable to acquire higher overall throughput. To achieve this, various standards and protocols have been introduced to reduce the medium overhead. One example that has been used in the past involves aggregating data packets. This allows many data packets destined to one STA to be aggregated so that the PHY layer overhead (e.g., preamble, signal fields, etc.), is incurred only once for the whole aggregate instead of on a per data packet basis. Another example utilizes the concept of multi-user, multiple-input multiple-output (hereinafter “MU-MIMO”) which allows transmission to multiple STAs using different spatial streams in parallel.

The above mechanisms works well when there is a large payload to be sent on each of the STA links. However, when this is not the case and there are smaller payloads that need to be sent to many STAs, the aggregation of data may not provide any benefit. The MU-MIMO mechanism may also not be used since its initial medium overhead needed for sounding will not be recovered over just a few small payloads.

In future networks, it is expected that small data payloads, or transmission of small data packets, are going to increase. For example, many devices may be wirelessly connected to the internet with many of these devices only sending small payloads. With many devices being utilized that generate or consume small payloads, the overall medium efficiency will decrease, degrading performance of those devices that require high throughput.

### SUMMARY

One aspect of an apparatus includes a processing system configured to communicate with a plurality of receivers including first and second receivers. The apparatus generates an aggregate data packet including a plurality of data packets including first and second data packets. The first data packet is destined to the first receiver and the second data packet is destined to the second receiver. The aggregate data packet includes a delimiter including a group identifier for determining, at the first receiver, that at least one of the data packets, including the first data packet, is destined to the first receiver and for determining, at the second receiver, that at least one of the data packets, including the second data packet, is destined to the second receiver.

One aspect of a method for communicating with a plurality of receivers including first and second receivers. The method includes generating an aggregate data packet including a plurality of data packets including first and second data packets. The first data packet is destined to the first receiver and the second data packet is destined to the second receiver. The aggregate data packet includes a delimiter including a group identifier for determining, at the first receiver, that at least one of the data packets, including the first data packet, is destined to the first receiver and for determining, at the second receiver, that at least one of the data packets, including the second data packet, is destined to the second receiver.

Another aspect of an apparatus for wireless communications includes a communicating means for communicating with a plurality of receivers including first and second receivers. The apparatus includes a generating means for generating an aggregate data packet including a plurality of data packets including first and second data packets. The first data packet is destined to the first receiver and the second data packet is destined to the second receiver. The aggregate data packet includes a delimiter including a group identifier for determining, at the first receiver, that at least one of the data packets, including the first data packet, is destined to the first receiver and for determining, at the second receiver, that at least one of the data packets, including the second data packet, is destined to the second receiver.

One aspect of a computer program product for an apparatus configured for wireless communication with a plurality of receivers including first and second receivers. The computer program includes a non-transitory computer-readable medium including code executable by one or more processors for generating an aggregate data packet including a plurality of data packets including first and second data packets. The first data packet is destined to the first receiver and the second data packet is destined to the second receiver. The aggregate data packet includes a delimiter including a group identifier for determining, at the first receiver, that at least one of the data packets, including the first data packet, is destined to the first receiver and for determining, at the second receiver, that at least one of the data packets, including the second data packet, is destined to the second receiver.

Another aspect of an apparatus includes a processing system configured to receive an aggregate data packet including a plurality of data packets each having an address, and a plurality of delimiters that each precede each data packet. At least one of the data packets is addressed to a remote apparatus. At least one delimiter includes a group identifier indicating whether at least one data packet is addressed to the apparatus. The processing system is configured to process the aggregate data packet when the group identifier indicates that at least one data packet is addressed to the apparatus by processing the data packets addressed to the apparatus.

Another aspect of a method of wireless communication includes receiving an aggregate data packet including a plurality of data packets, each having an address, and a plurality of delimiters that each precede each data packet. At least one of the data packets is addressed to a remote apparatus. At least one delimiter includes a group identifier indicating whether at least one data packet is addressed to the apparatus. The method processes the aggregate data packet when the group identifier indicates that at least one data packet is addressed to the apparatus by processing the data packets addressed to the apparatus.

Another aspect of an apparatus for wireless communications includes a receiving means for receiving an aggregate data packet comprising a plurality of data packets, each having an address, and a plurality of delimiters each preceding each data packet. At least one of the data packets is addressed to a remote apparatus. At least one delimiter includes a group identifier indicating whether at least one data packet is addressed to the apparatus. The apparatus includes a processing means for processing the aggregate data packet when the group identifier indicates that at least one data packet is addressed to the apparatus by processing the data packets addressed to the apparatus.

Another aspect of a computer program product for an apparatus configured for wireless communication with a transceiver includes a non-transitory computer-readable medium including code executable by one or more processors for receiving an aggregate data packet including a plurality of data packets, each having an address, and a plurality of delimiters each preceding each data packet. At least one of the data packets is addressed to a remote apparatus. At least one delimiter includes a group identifier indicating whether at least one data packet is addressed to the apparatus. The apparatus includes a processing means for processing the aggregate data packet when the group identifier indicates that at least one data packet is addressed to the apparatus by processing the data packets addressed to the apparatus.

It is understood that other aspects of apparatuses and methods will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of apparatuses and methods will now be presented in the detailed description by way of example, and not by way of limitation, with reference to the accompanying drawings, wherein:

FIG. 1 is a conceptual diagram illustrating an example of various aspects of a wireless network.

FIG. 2 is a conceptual diagram illustrating an example of various aspects of a protocol stack having a layered structure.

FIG. 3 is a diagram illustrating an example of various aspects of a basic delimiter.

FIG. 4 is a diagram illustrating an example of various aspects of an extended delimiter.

FIG. 5 is a diagram illustrating an example of various aspects of a super set delimiter.

FIGS. 6A-6C are diagrams illustrating examples of various aspects of an aggregate data packet.

FIG. 7 is a diagram illustrating an example of various aspects of an acknowledgment protocol in a multi station environment.

FIG. 8A is a block diagram illustrating an example of various aspects of a hardware configuration for a processing system in a STA in the wireless communications network of FIG. 1.

FIG. 8B is a block diagram illustrating an example of various aspects of a hardware configuration for a processing system in an AP in the wireless communications network of FIG. 1.

FIG. 9A is a flow chart illustrating an example of various aspects of a method of transmitting a data packet from an AP to a STA.

FIG. 9B is a flow chart illustrating an example of various aspects of a method of receiving a data packet from an AP to a STA.

FIG. 10 is a flow chart illustrating an example of various aspects of a method of receiving a data packet from an AP to a STA as executed by a processing system.

FIG. 11 is a flow chart illustrating an example of various aspects of a method of transmitting a data packet from an AP to a STA as executed by a processing system.

### DETAILED DESCRIPTION

Various concepts will be described more fully hereinafter with reference to the accompanying drawings. These concepts may, however, be embodied in many different forms by those skilled in the art and should not be construed as limited to any specific structure or function presented herein. Rather, these concepts are provided so that this disclosure will be thorough and complete, and will fully convey the scope of these concepts to those skilled in the art. The detailed description may include specific details However, it will be apparent to those skilled in the art that these concepts may be practiced without these specific details. In some instances, well known structures and components are shown in block diagram form in order to avoid obscuring the various concepts presented throughout this disclosure.

These concepts will now be presented with reference to various apparatus and methods. These apparatus and methods will be described in the following detailed description and illustrated in the accompanying drawings by various elements comprising blocks, modules, components, circuits, steps, processes, algorithms, and the like. These elements, or any field thereof, either alone or in combinations with other elements and/or functions, may be implemented using electronic hardware, computer software, or any combination thereof. Whether such elements are implemented as hardware or software depends upon the particular application and design constraints imposed on the overall system.

By way of example, an element, or any field of an element, or any combination of elements may be implemented with a “processing system” that includes one or more processors. A processor may include a general purpose processor, a digital signal processor (DSP), an application specific integrated circuit (ASIC), a field programmable gate array (FPGA) or other programmable logic component, discrete gate or transistor logic, discrete hardware components, or any combination thereof, or any other suitable component designed to perform the functions described herein. A general-purpose processor may be a microprocessor, but in the alternative, the processor may be any conventional processor, controller, microcontroller, or state machine. A processor may also be implemented as a combination of computing components, e.g., a combination of a digital signal processor (DSP) and a microprocessor, a plurality of microprocessors, one or more microprocessors in conjunction with a DSP, or any other such configuration.

One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A non-transitory computer-readable medium may include, by way of example, a magnetic storage device (e.g., hard disk, floppy disk, magnetic strip), an optical disk (e.g., compact disk (CD), digital versatile disk (DVD)), a smart card, a flash memory device (e.g., card, USB stick, key drive), random access memory (RAM), static RAM (SRAM), dynamic RAM (DRAM), synchronous dynamic RAM (SDRAM); double date rate RAM (DDRAM), read only memory (ROM), programmable ROM (PROM), erasable PROM (EPROM), electrically erasable PROM (EEPROM), a general register, or any other suitable non-transitory medium for storing software.

The various interconnections between elements may be shown as buses or as single signal lines. Each of the buses may alternatively be a single signal line, and each of the single signal lines may alternatively be buses, and a single line or bus might represent any one or more of a myriad of physical or logical mechanisms for communication between elements. Any of the signals provided over various buses described herein may be time-multiplexed with other signals and provided over one or more common buses. The term “coupled” as used herein means connected directly to or connected through one or more intervening elements.

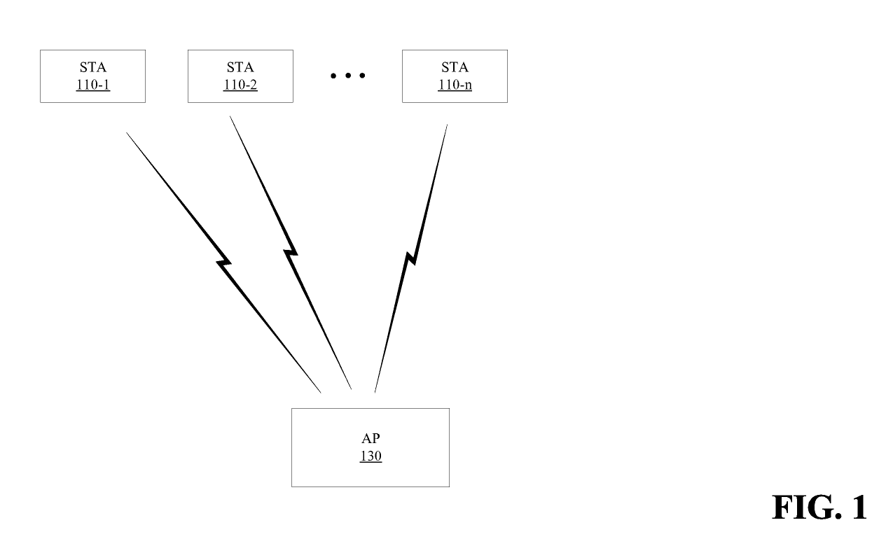

FIG. 1 is a conceptual diagram illustrating an example of various aspects of a wireless network 100 within which the various concepts presented herein can be implemented. In the detailed description that follows, the wireless network 100 will be described as a WLAN, such as, for example, an IEEE 802.11 network. However, as those skilled in the art will readily appreciate, the various aspects described throughout this disclosure may be extended to other networks employing various standards or protocols including, by way of example, BLUETOOTH® (Bluetooth), HiperLAN (a set of wireless standards, comparable to the IEEE 802.11 standards, used primarily in Europe), and other technologies used in wide area networks (WAN)s, WLANs, personal area networks (PAN)s, or other suitable networks now known or later developed. The various aspects presented throughout this disclosure may be applicable to any suitable wireless network 100 regardless of the coverage range and the wireless access protocols utilized.

The wireless network 100 may support any number of apparatus. An apparatus may be any suitable wireless device capable of operating in a wireless environment, such an AP 130 or a STA 110 operating in an 802.11 compliant network. An AP 130 is generally a fixed terminal that provides backhaul services to STAs 110 in its coverage region; however, the AP 130 may be mobile in some applications. A STA 110, which may be fixed or mobile, utilizes the backhaul services of an AP 130 to connect to another network, such as the Internet. Examples of a STA 110 include, but are not limited to, a cellular phone, a smart phone, a laptop computer, a desktop computer, a personal digital assistant (PDA), a personal communication system (PCS) device, a personal information manager (PIM), personal navigation device (PND), a global positioning system, a multimedia device, a video device, an audio device, or any other suitable wireless apparatus requiring the backhaul services of an AP 130. A STA 110 may also be referred to by those skilled in the art as a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, user equipment (UE), or some other suitable terminology. An AP 130 may also be referred to as a base station, a base transceiver station, a radio base station, a radio transceiver, a transceiver function, or any other suitable terminology. The various concepts described throughout this disclosure are intended to apply to all suitable wireless apparatus regardless of their specific nomenclature.

Turning to FIG. 1, the wireless network 100 is shown with an AP 130 and a number of wireless STAs 110-1, 110-2 . . . 110-n within the coverage region of the AP 130. There may be any number, n, of STAs 110 in the wireless network 100 as illustrated by 110-n. The AP 130 provides backhaul services to STAs 110 over a wireless channel. The STAs 110-1, 110-2 . . . 110-n may gain access to the wireless channel using any suitable protocol (for example, an 802.11 compliant WLAN carrier sensing protocol). However, as those skilled in the art will appreciate, the various concepts described throughout this disclosure are equally applicable to any suitable apparatus regardless of the protocol or standard used to communicate over a network.

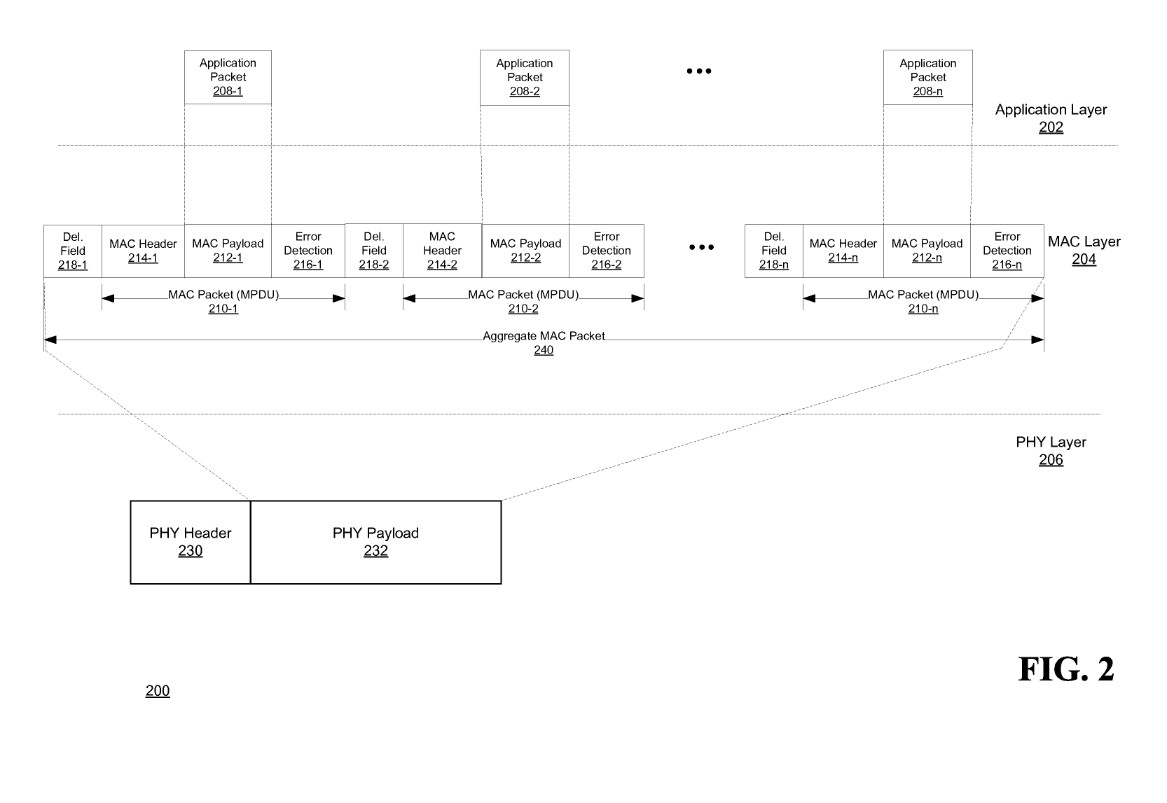

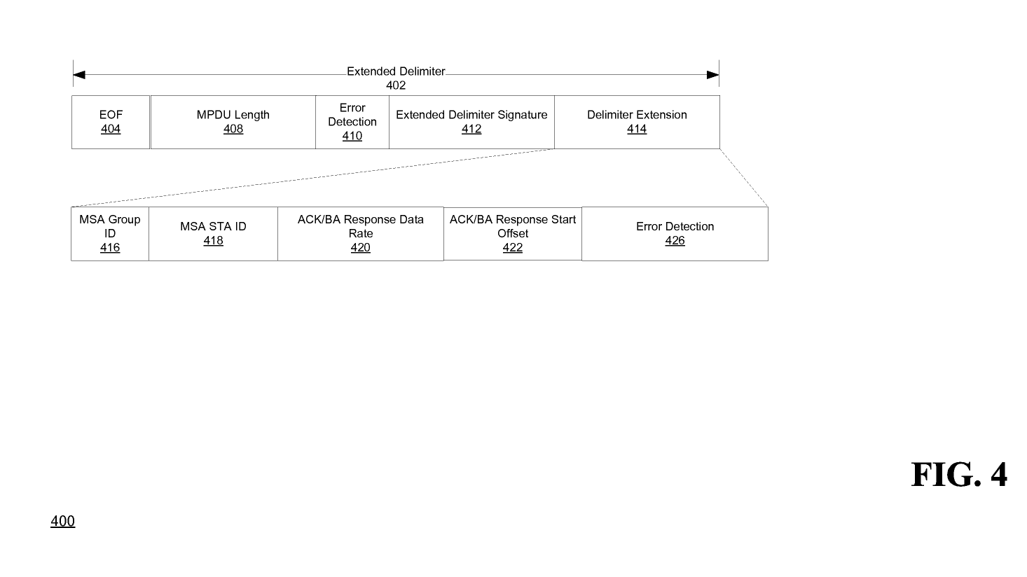

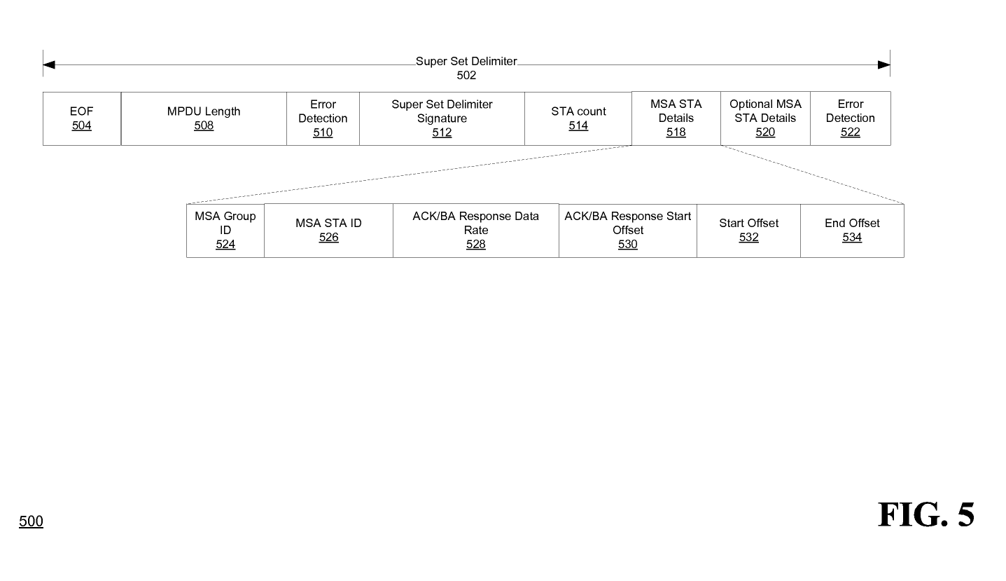

Various aspects of a WLAN will now be presented with multiple STAs 110 configured to receive small payloads. This may be achieved efficiently by aggregating data packets for different STAs 110. Data packets are broadcast by the AP 130 in a stream (e.g., the stream may be any suitable beam such as an omni-directional beam, a directional beam or any other method known to one skilled in the art) such that every STA 110 may detect the stream of data packets. A stream of data packets is referred to as an aggregate data packet which will be described in greater detail below with respect to FIG. 2. Each data packet may include a data packet header that may include various pieces of information such as the destination address. The destination address represents the address of the STA 110 for which a data packet is destined to. The STA 110 may then compare the destination address within the data packet header for each data packet in the stream of data packets with its own address to determine whether or not a packet is one destined for a particular STA 110. Two delimiter types, such as an extended delimiter or a super set delimiter may alternatively store the destination address of a particular receiving STA instead of storing the address in the header of the MPDU. This will be described in further detail below with respect to FIG. 4 and FIG. 5.

An apparatus, whether it is a wireless access point (AP 130) or a wireless station (STA 110), may be implemented with a protocol that utilizes a layered structure. FIG. 2 is a conceptual diagram 200 illustrating an example of various aspects of a protocol stack having a layered structure. By way of example, as shown in FIG. 2, a layered structure may include an application layer 202, a Medium Access Control (MAC) layer 204 and a physical (PHY) layer 206. The physical layer 206 implements all the physical and electrical specifications to interface the apparatus to the shared wireless channel. The MAC layer 204 coordinates access to the shared wireless channel and is used to interface higher layers, such as the application layer 202, to the PHY layer 206. The application layer 202 performs various data processing functions including, by way of example, speech and multimedia codecs and graphics processing. Additional protocol layers (e.g., network layer, transport layer) may be required for any particular application. Those skilled in the art will be readily able to implement the appropriate protocol for any wireless apparatus depending on the particular application and the overall design constraints imposed on the overall system.

When the apparatus is in a transmit mode, the application layer 202 generates and processes data, segments the data into a plurality of application data packets 208-1 to 208-n, and provides the plurality of application data packets 208-1 to 208-n to the MAC layer 204. The MAC layer 204 assembles a plurality of MAC packets 210-1 to 210-n, with each application data packet comprising a MAC payload. A MAC packet is sometimes referred to as a MAC Protocol Data Unit (MPDU), but may also be referred to as a frame, sub frame, packet, data packet, timeslot, segment, or any other suitable nomenclature.

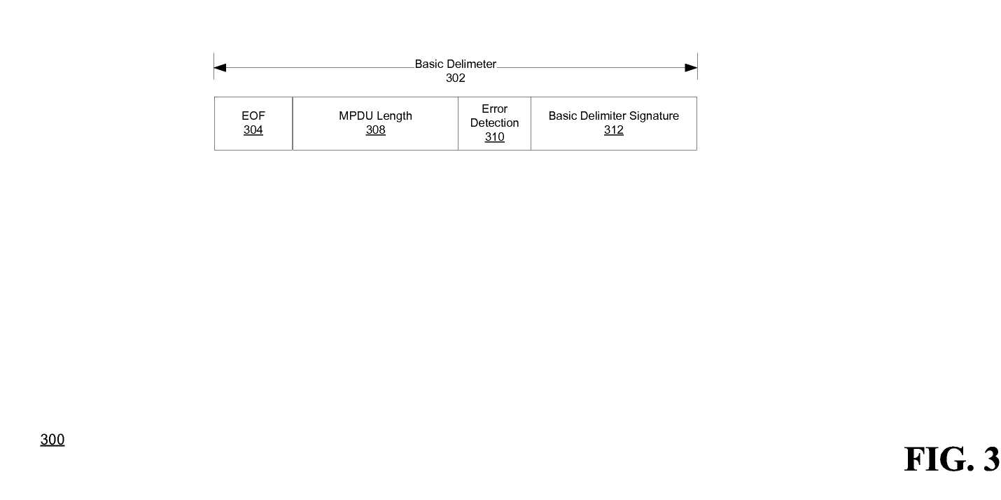

In addition to a payload, each MAC packet includes a MAC header and an error detection field. FIG. 2 indicates a typical structure of an MPDU with a MAC header 214-1 and an error detection field 216-1 in addition to the MAC payload 212-1. Although FIG. 2 shows one application layer data packet per each MAC packet, it is possible to incorporate multiple application layer data packets into the payload of one MAC packet. Alternatively, multiple application layer data packets may be fragmented and distributed over more than one MAC packet. The MAC packets 210-1 to 210-n are then placed into the payload of a PHY layer packet to be transmitted, as further described herein. In addition, before each MAC packet (MPDU) 210, there is a delimiter field 218-1, 218-2 . . . 218-n which will be discussed in greater detail below with respect to FIGS. 3-5. The delimiter field 218 includes one of multiple delimiter types (e.g., basic, extended, super set) which may describe the length of the subsequent MPDU 210. In addition, based on the type of delimiter in the delimiter field 218, additional information may include whether or not any of the MPDUs 210-1 . . . 210-n in the aggregate packet 240 are designated for a particular STA. For example, in the aggregate MAC packet 240 (or AMPDU), the first or front-end delimiter field 218-1 may be an extended type delimiter which indicates to a receiving STA whether or not any of the MPDUs 210-1 through 210-n are destined for a receiving STA. Furthermore, if the first delimiter field 218-1 is a super set delimiter, in addition to the functionality of an extended type delimiter it may also indicate the location of which MPDU 210-1 through 210-n within the aggregate MAC packet 240 is destined for a particular STA. An extended or super set delimiter may be used generally in the front-end or first delimiter field 218-1 to provide information regarding the remaining MPDUs 210-1 to 210-n to a receiving STA. The remaining delimiter fields 218-2 through 218-n may generally then include basic delimiters to solely indicate the length of a subsequent MPDU that follows it. A receiving STA may read the address in the MAC header 214 of the MPDU 210 to determine whether or not the address matches the address of the receiving STA, and consequently whether or not the MPDU 210 is destined for that STA. The MAC header 214 of the MPDU 210 generally includes the address of a receiving STA only if the delimiter that precedes it is a basic type delimiter. For an extended or super set delimiter (described in further detail below), the address may be located in a field of the delimiter rather than in the header of the subsequent MPDU 210.

The partial PHY packet shown in FIG. 2 in the PHY layer 206 is a PHY Payload 232 and a PHY Header 230. The PHY Payload 232 carries the MAC packets 210-1 to 210-n to a physical medium (e.g., a transceiver). A PHY header 230 is provided before the PHY layer payload 232 to direct the MAC packets in the payload to the correct STA. Each MAC packet 210-1 to 210-n in an aggregate MAC packet 240 is broadcast to all STAs. Each STA then determines which MAC packet 210-1 to 210-n is destined for that STA.

FIG. 3 is a diagram 300 illustrating an example of various aspects of a basic delimiter 302. A basic delimiter 302 is generated by the transceiver. For example, the transceiver may be the AP 130 discussed above with respect to FIG. 1. After transmission by the AP 130, the basic delimiter 302 is then read and decoded by a STA to determine the length of the MPDU that immediately follows it. For example, referring to FIG. 2, assuming all delimiter fields 218 are basic delimiters 302, then 218-1 indicates to the receiving STA the length of MPDU 210-1, 218-2 for MPDU 210-2, and 218-n for MPDU 218-n. Every basic delimiter 302 is read in the aggregate packet 240 in order to determine the length of the MPDU that follows it. The basic delimiter 302 includes an end of frame, or EOF, field 304, an MPDU length field 308, an error detection field 310, and a basic delimiter signature 312. The EOF field 304 may be a single bit in length to indicate the end of a data payload. The MPDU length field 308 may indicate the length of the subsequent MPDU 210 (see FIG. 2) following the basic delimiter 302. The next field of the basic delimiter 302 is the error detection field 310. The error detection field 310 may be used to assist the STA to ensure that the basic delimiter 302 was not corrupted during transmission and that it is properly decoded. The next field of the basic delimiter 302 is the basic delimiter signature 312. The basic delimiter signature 312 may be a unique pattern that may be used by the STAs to detect an MPDU delimiter while scanning.

FIG. 4 is a diagram 400 illustrating an example of various aspects of an extended delimiter 402. The extended delimiter 402 provides additional functionality compared to the basic delimiter 302, in that it also indicates to the STA if there are any MPDU's in the aggregate MPDU that belong to that particular STA, based on a group identifier value. Therefore, if the STA reads the extended delimiter 402 and determines no MPDU in that particular aggregate belong to it based on the group identifier value, it may terminate its reception. For example, referring back to FIG. 2, if the delimiter field 218-1 is an extended delimiter 402, it would indicate to a STA whether or not any of the MPDUs 210-1, 210-2 . . . 210-n that follow the extended delimiter 402 are destined to it (this is based on a group identifier field in the extended delimiter 402). If the delimiter field 218-1 is a basic delimiter 302 and 218-2 is an extended delimiter 402, the STA only knows whether or not any of the MPDUs 210-2 . . . 210-n that follow the extended delimiter 402 are destined to it. The extended delimiter 402 includes EOF 404, MPDU length 408 and error detection 410 fields which are as described above with respect to FIG. 3. The extended delimiter signature 412 may indicate that the delimiter is an extended type delimiter. The next field of the extended delimiter is the delimiter extension 414 which may contain additional information, such as group identification which will be described in detail below.

The first field of the delimiter extension 414 is the MSA group ID 416 which identifies a corresponding group of STAs for each of the MPDUs in the aggregate MPDU. An STA may be grouped together with other STAs regardless of any commonality. The STA may include a group identifier indicating to which group it may belong. Referring back to FIG. 2, there may be three MPDU packets 210-1, 210-2 and 210-3 belonging to the aggregate MPDU 240. If the delimiter field 218-1 is an extended delimiter 402, a STA will read the MSA group ID 416 to determine whether or not any MPDU packet 210-1, 210-2 and 210-3 in the aggregate packet 240 are destined to it. For example, when an STA reads the MSA group ID, compares it with its own group number and does not find a match (and consequently determines that none of the MPDU's 210-1, 210-2 and 210-3 are a part of that STA's group) it may terminate its reception of the AMPDU 240. Conversely, if a STA reads the MSA group ID and finds a match with its own group identification value (which consequently indicates that at least one of the MPDU's 210-1, 210-2 or 210-3 are destined for that particular STA), the STA can continue processing the AMPDU 240. The extended delimiter does not indicate which MPDU 210-1, 210-2 or 210-3 within the aggregate MPDU 240 is destined for that particular STA. This is achieved by a super set delimiter which will be discussed in greater detail below with respect to FIG. 5.

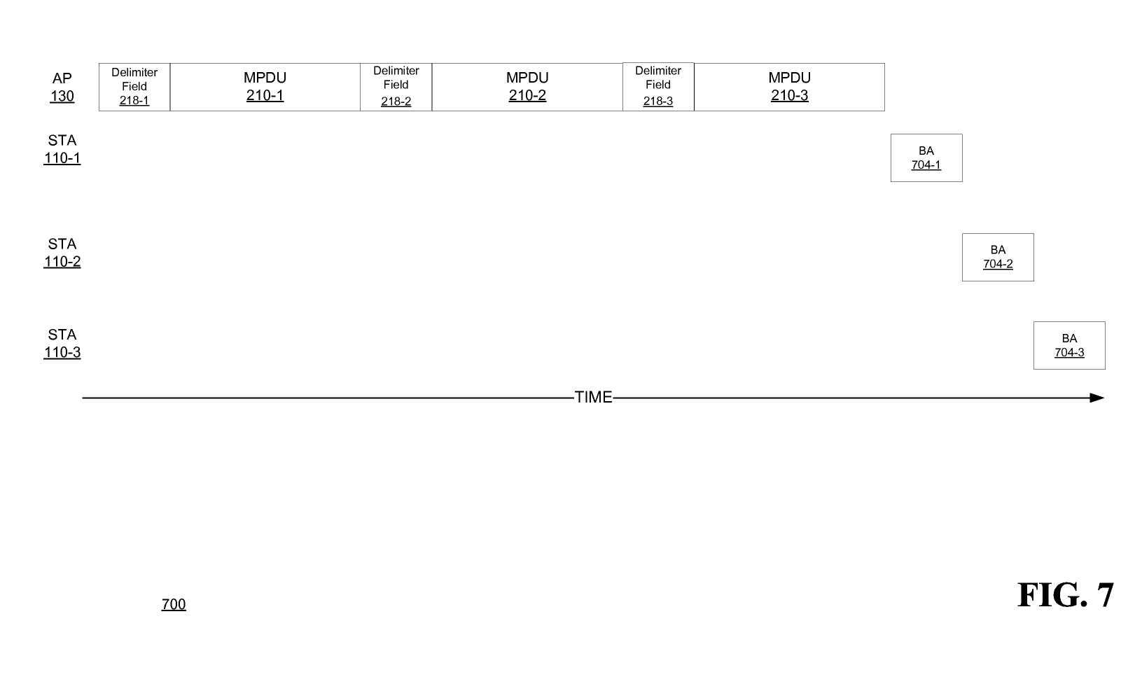

The next field of the delimiter extension 414 is the MSA STA ID 418. The MSA STA ID 418 is identification or the address for the MPDU that immediately follows the extended delimiter 402. If the MSA STA ID 418 is not equal to a STA's MSA STA ID, the STA can skip reception of the MPDU immediately following the extended delimiter 402. Furthermore, the MSA STA ID 418 replaces the need to include the identification or address of the MPDU that immediately follows it in the MPDU header as done by a basic delimiter 302. For an extended delimiter 402, the address of the subsequent MPDU that follows it is located in the extended delimiter 402 MSA STA ID 418 field rather than in the MPDU header. However, in some cases, the MPDU following an extended delimiter may still include the STA address field even though it is also included in the preceding delimiter. In such cases, the STA may determine whether to use the address from MSA STA ID 418 in the extended delimiter or the address from the following MPDU header to determine whether to skip reception of the MPDU. Alternatively, in some cases, the delimiter extension 414 may not include MSA STA ID 418. In such cases, the STA may use the STA address from the MPDU that immediately follows the delimiter to determine if the STA should skip reception of the MPDU. The next field of the delimiter extension 414 is the ACK/BA response data rate 420. Once a STA receives a data packet, it may notify the AP in return with a block acknowledgement message indicating successful receipt of the data packet. A block acknowledgement (also known as a “block ACK”, or “BA”) response data rate may be the rate of response for the STA to use to send their block acknowledgment messages in response to incoming payloads from an AP. The extended delimiter 402 may set the BA response data rate 420 to indicate to a STA an ideal response rate for a block acknowledgement message. The next field of the delimiter extension 414 is the ACK/BA response start offset 422. The ACK/BA response start offset 422 is a timing offset that the STA may use to send an ACK to acknowledge receipt of an aggregate MPDU. This will be discussed in further detail with respect to FIG. 7 below. Finally, the last field of the delimiter extension 414 is the error detection field 426 which may be used to assist the STA to ensure that the extended delimiter 402 was not corrupted during transmission and that it is properly decoded.

FIG. 5 is a diagram 500 illustrating an example of various aspects of a super set delimiter 502. The super set delimiter 502 contains an end of frame 504 field, MPDU length 508, error detection 510 field which are the same as discussed above with respect to FIGS. 3-4. The super set delimiter signature 512 indicates the delimiter is a super set type delimiter. The STA count 514 field indicates the number of STAs that will be addressed in the AMPDU 240. The MSA STA Details 518 field expands into an MSA group ID 524, MSA STA ID 526, ACK/BA response data rate 528 and an ACK/BA response start offset 530 which are the same as discussed above with respect to FIG. 4. An additional field is the start offset 532 which may indicate where in the aggregate data packet 240 a data packet destined for a STA may be located. This adds additional functionality compared to the extended delimiter 402 which solely states there is an MPDU in the AMPDU that is destined for a receiving STA (based on the group identification, or MSA group ID 416). The super set delimiter 502 adds additional functionality by providing the STA with the start location of the MPDU destined for that STA. The end offset 534 indicates up to where (for example, the location of the last MPDU in the aggregate MPDU) in the AMPDU the MPDUs destined for a STA may be found. After this offset, no additional MPDUs for that STA will be located within the AMPDU. The super set delimiter 502 further includes the next field which may be the optional MSA STA details 520 which may include additional details related for a STA addressed by the AMPDU. Finally, error detection 522 is the final field of the super set delimiter 502 which may provide additional error detecting capabilities.

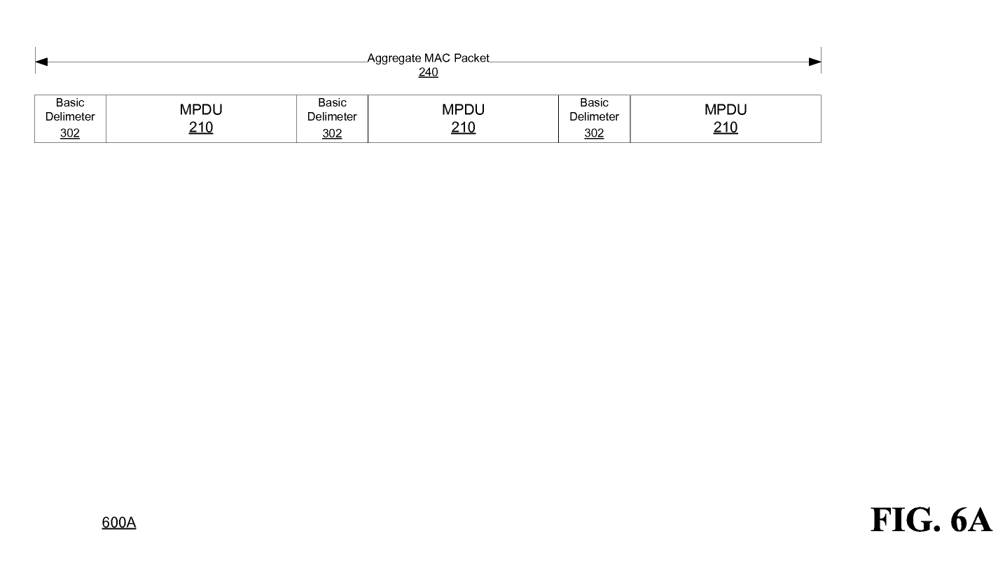

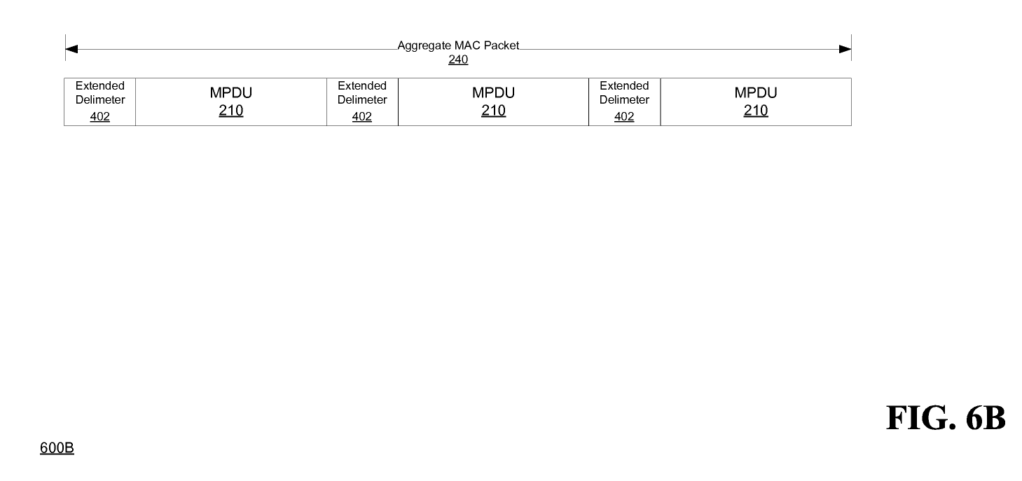

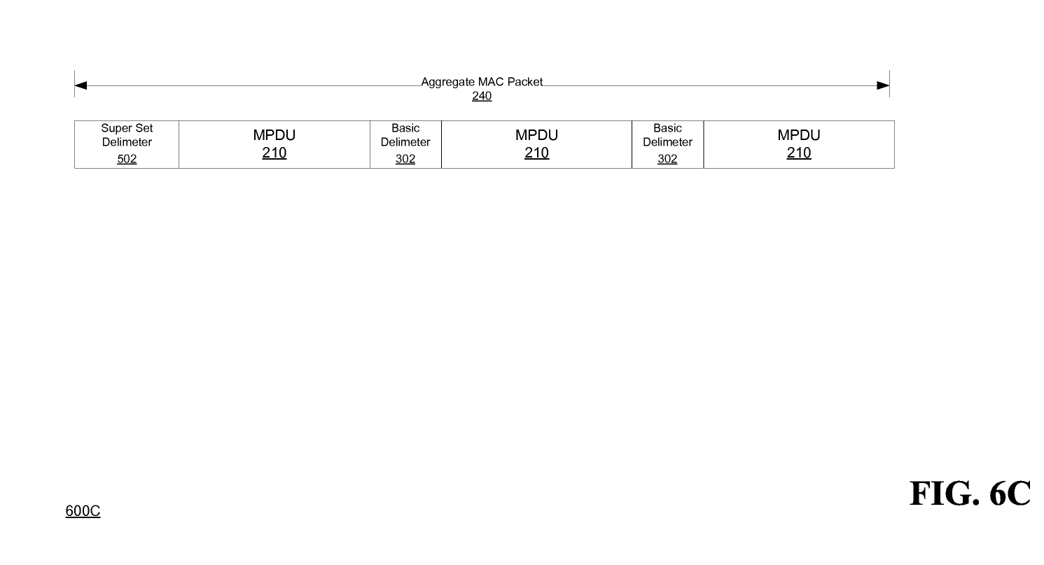

FIG. 6A shows an illustration 600A of one embodiment of an aggregate MAC packet, or AMPDU 240. There may be a basic delimiter 302 before every MPDU 210. Although there are only three basic delimiters 302 and MPDUs 210 shown here, the AMPDU 240 structure is not solely limited to that quantity. Furthermore, for redundancy, there may be additional copies of the basic delimiter 302 before each MPDU 210. FIG. 6B shows an illustration 600B of another embodiment of an aggregate MAC packet, or AMPDU 240. Here, there are extended delimiters 402 instead of basic delimiters 302 before each MPDU 210. Finally, FIG. 6C is an illustration 600C of a further embodiment showing a super set delimiter 502 as the first delimiter type in the group, followed by basic delimiters 302 preceding the remaining MPDUs 210.

Although FIGS. 6A through 6C illustrate three different examples of an AMPDU 240 configuration, there may be many additional permutations or configurations that may also be used which are known to one skilled in the art.

FIG. 7 is a diagram 700 illustrating an example of various aspects of an acknowledgment protocol in a multi station environment. In this illustration 700, there are only three MPDUs, but any number may be supported. For example, MPDU 210-1, 210-2 and 210-3 may be associated with three different STAs (STA 110-1, STA 110-2 and STA 110-3 respectively). Furthermore, STAs 110-1 to 110-3 may be all part of the same group. The delimiter field 218 may include an extended delimiter 402 thereby indicating that every MPDU 210-1, 210-2 and 210-3 belong to the same group. Therefore, STAs 110-1, 110-2 and 110-3 will allow data packets to be received upon receiving the first delimiter with an associated MSA Group ID 416. Upon receipt of an MPDU, each STA 110-1 to 110-3 will respond with a BA 704-1 to 704-3 respectively at the time offset indicated in the delimiter. The BAs 704-1 to 704-3 may each include the same content or different content. Each BA 704-1 to 704-3 is a block acknowledgement, or an acknowledgment sent from one of the STAs 110-1 to 110-3 to the AP 130 indicating successful receipt of data. For example, when STA 110-1 receives MPDU 210-1 it will send its BA 704-1 (STA 110-2 sends its BA 704-2 after receiving MPDU 210-2, and STA 110-3 sends its BA 704-3 for MPDU 210-3). Each BA 704-1 to 704-3 is allocated a unique time slot such that there are no BA collisions. As shown in the illustration 700, the 3 BAs 704-1 to 704-3 are spaced apart for each STA 110-1 to 110-3.

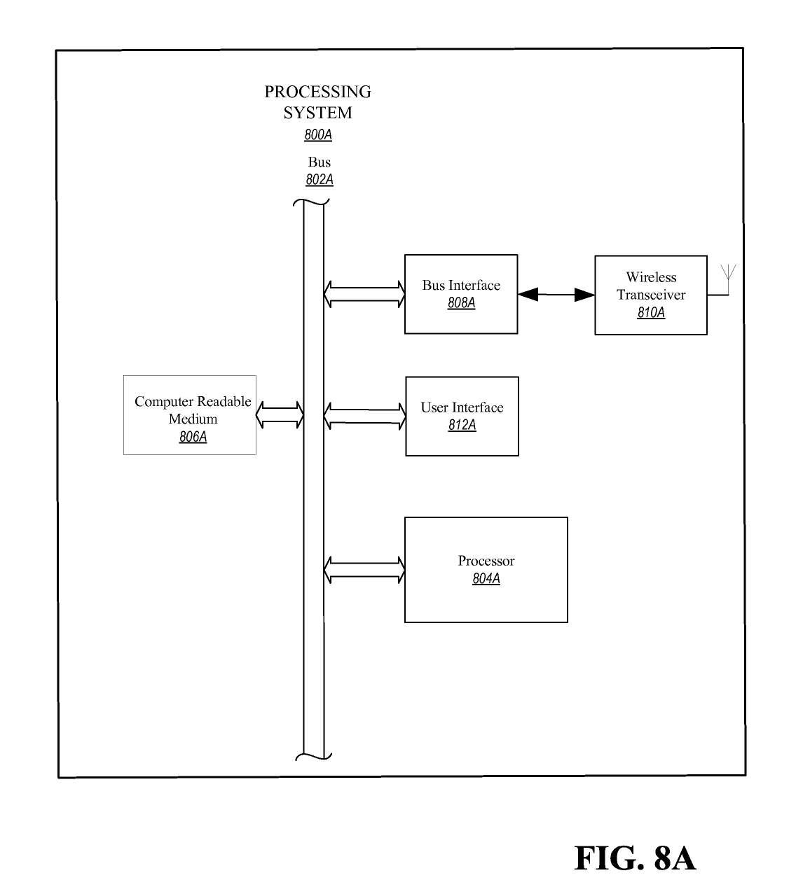

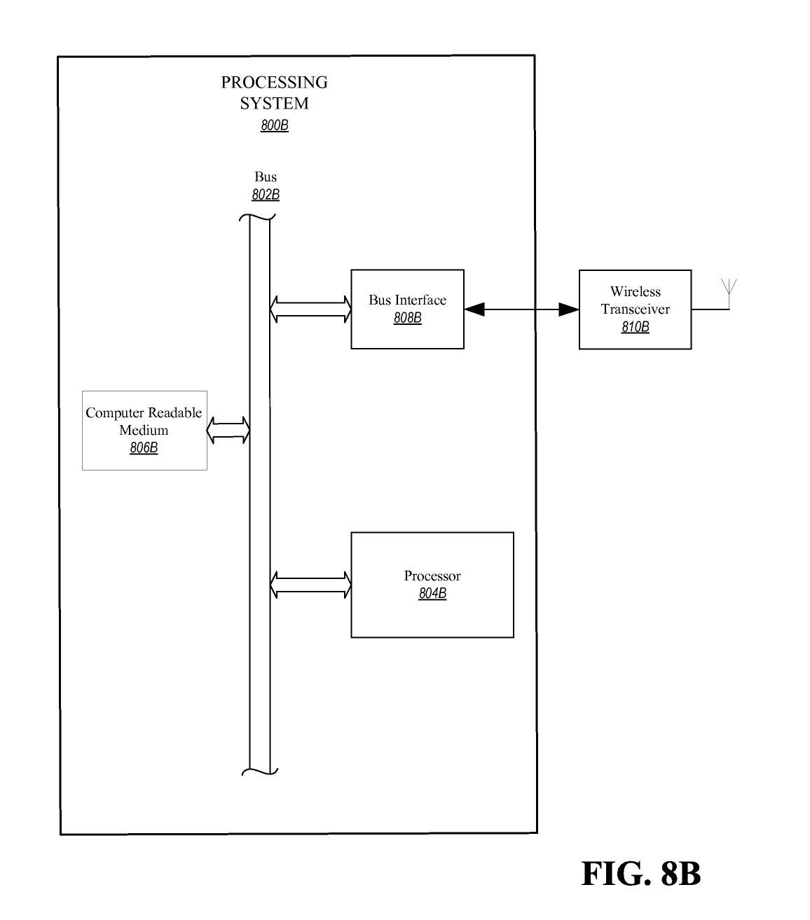

FIG. 8A is a block diagram illustrating an example of various aspects of a hardware configuration for a processing system 800A in a STA 110 in the wireless communications network of FIG. 1. In this example, the processing system 800A may be implemented with a bus architecture represented generally by bus 802A. The bus 802A may include any number of interconnecting buses and bridges depending on the specific application of the processing system 800A and the overall design constraints. The bus links together various circuits including a processor 804A, computer readable medium 806A, and a bus interface 808A. The bus interface 808A may be used to connect a wireless transceiver 810A, among other things, to the processing system 800A via the bus 802A. Although shown as a part of the processing system 800A, the wireless transceiver 810A may also reside outside the processing system 800A as a separate entity. The wireless transceiver 810A may provide a receiving means for receiving an aggregate data packet comprising a plurality of data packets each having an address, wherein at least one of the data packets is addressed to a different STA. Furthermore, the transceiver 810A may provide a transmitting means for transmitting (e.g., to an AP) an acknowledgement at a scheduled time for each of the received data packets in an aggregate data packet that is address to the receiving STA. A user interface 812A (e.g., keypad, display, mouse, joystick, etc.) may also be connected to the bus 802A. The bus 802A may also link various other circuits such as timing sources, peripherals, voltage regulators, power management circuits, and the like, which are well known in the art, and therefore, will not be described any further.

The processor 804A is responsible for managing the bus and general processing, including the execution of software stored on the computer readable medium 806A. The computer readable medium 806A may store software that when executed by the processor 804A may perform certain functions. The processor 804A may be responsible for executing software which may provide a processing means for processing only the data packets addressed to the STA as discussed above. Furthermore, the processor 804A may execute software which may provide a comparing means for comparing the address in the header of each data packet to an address of an apparatus, and processing means for processing the data packets with the address matching the address of the receiving STA. In addition, the processor 804A may execute software which may provide a dropping means for dropping the data packets with the address not matching the address of the receiving STA.

In the hardware implementation illustrated in FIG. 8A, the computer readable medium 806A is shown as part of the processing system 800A separate from the processor 804A. However, as those skilled in the art will readily appreciate, the computer readable medium 806A, or any field thereof, may be external to the processing system 800A. Although shown separately from the processor, the computer readable medium may be integrated into the processor 804A. The computer readable media or any portion thereof may be integrated into the processor 804A.

FIG. 8B is a block diagram illustrating an example of various aspects of a hardware configuration for a processing system 800E in an AP 130 in the wireless communications network of FIG. 1. In this example, the processing system 800E may be implemented with a bus architecture represented generally by bus 802B. The bus 802B may include any number of interconnecting buses and bridges depending on the specific application of the processing system 800E and the overall design constraints. The bus links together various circuits including a processor 804B, computer readable medium 806B and a bus interface 808B. The bus interface 808B may be used to connect a wireless transceiver 810B, among other things, to the processing system 800E via the bus 802B. Although shown as a separate entity from the processing system 800B, the wireless transceiver may also reside inside the processing system 800B. The wireless transceiver 810E may provide a communicating means for communicating with a plurality of STAs. Furthermore, the transceiver 810E may provide a transmitting means for transmitting an aggregate data packet with a single omni-directional beam, or any other suitable beam. In addition, the transceiver 810E may provide a receiving means for receiving an acknowledgement message from an STA at a scheduled time for each of a plurality of data packets in an aggregate data packet that is addressed to a STA. The bus 802B may link various other circuits such as timing sources, peripherals, voltage regulators, power management circuits, and the like, which are well known in the art, and therefore, will not be described any further.

The processor 804B is responsible for managing the bus and general processing, including the execution of software stored on the computer readable medium 806B. The computer readable medium 806B may store software that when executed by the processor 804B may perform certain functions. Although shown separately from the processor, the computer readable medium may be integrated into the processor 804B. The processor 804B while executing the software may provide a generating means for generating an aggregate data packet comprising a plurality of data packets, wherein each of the data packets is destined to a different one of the plurality of STAs.

In the hardware implementation illustrated in FIG. 8B, the computer readable medium 806B is shown as part of the processing system 800E separate from the processor 804B. However, as those skilled in the art will readily appreciate, the computer readable medium 806B, or any field thereof, may be external to the processing system 800B.

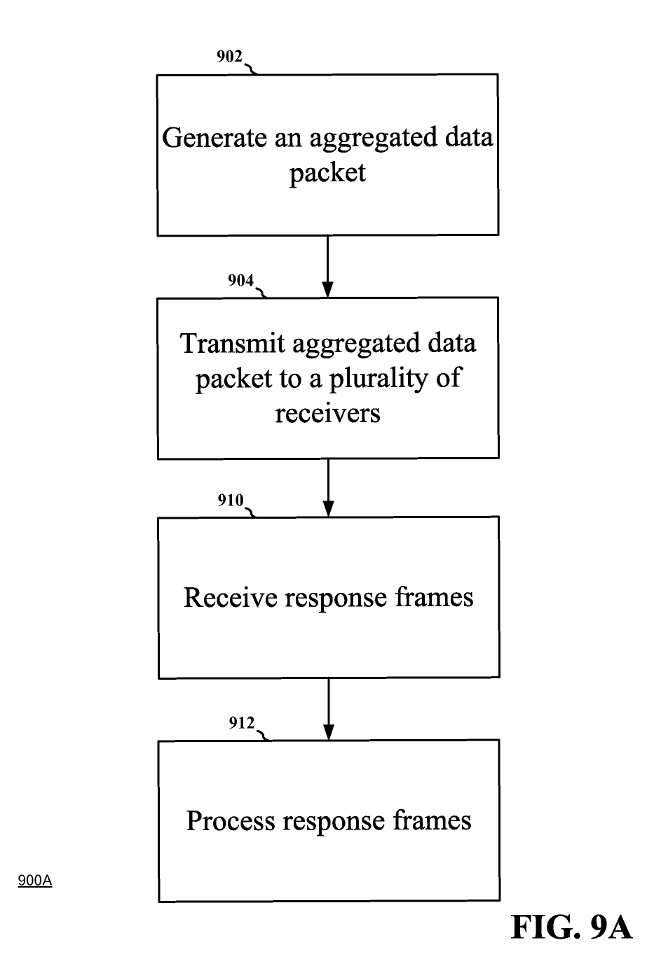

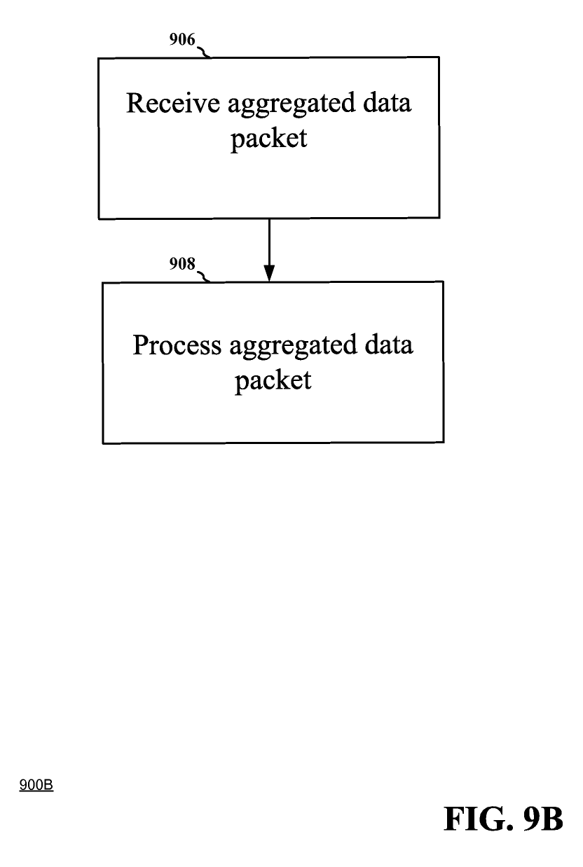

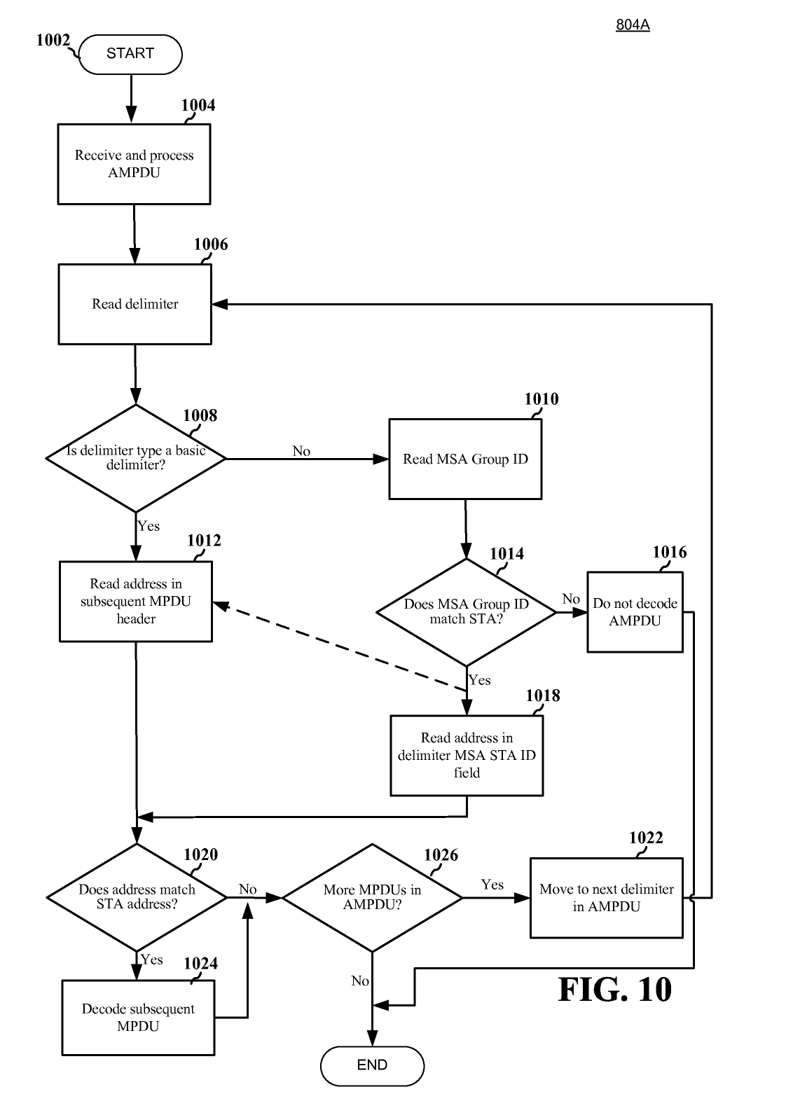

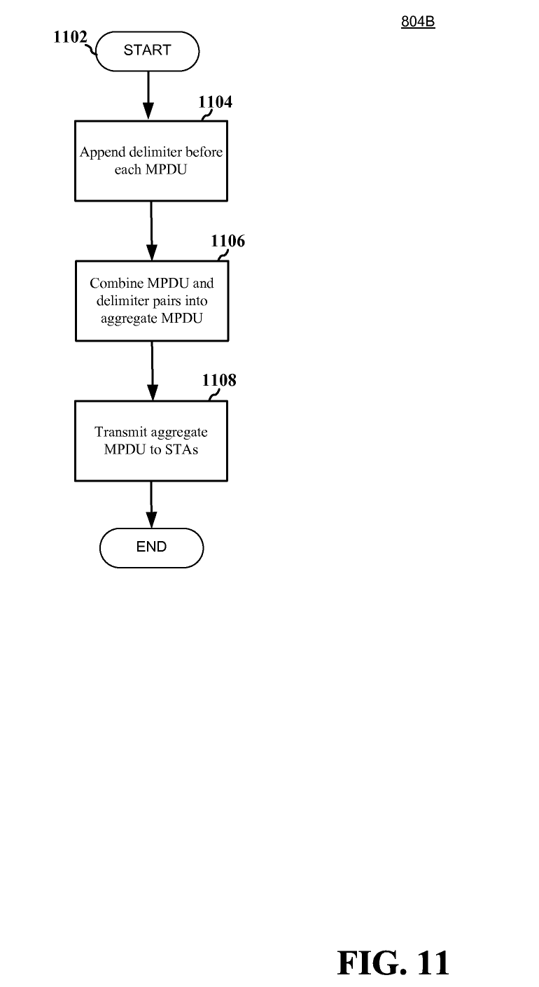

FIG. 9A is a flow chart 900A illustrating an example of various aspects of a method of transmitting a data packet from an AP to a STA. The software residing on computer readable mediums 806A and 806B when executed by processors 804A and 804B may perform the following functions for the STA and the AP, respectively. The AP 130 may generate an aggregate data packet as shown by block 902. The AP 130 may then transmit the aggregate data packet to a plurality of receivers or STAs 110 as shown by block 904. As shown by block 910, after transmitting the aggregate data packet, the AP may receive response frames from the STAs such as the block acknowledgment described above in FIG. 7. The AP may then process the received response frames as shown by block 912. This will be discussed in greater detail below with respect to FIG. 11. FIG. 9B is a flow chart 900E illustrating an example of various aspects of a method of receiving a data packet from an AP to a STA. The STA 110 may then receive the aggregate data packet and process it as shown in blocks 906 and 908. This will be discussed in greater detail below with respect to FIG. 10.

FIG. 10 is a flow chart illustrating an example of various aspects of a method of receiving a data packet from an AP to a STA as executed by a processing system. This may be performed by software executed by the processor 804A within the processing system 800A discussed above with respect to a STA, or by other means known to one skilled in the art. The process begins at 1002 and continues to 1004 when a STA receives and processes an incoming aggregate data packet, or AMPDU. The process continues to 1006 to read the next delimiter in the AMPDU. The process continues to decision 1008 to determine whether or not the delimiter is a basic type delimiter. If the delimiter is not a basic type delimiter, but is an extended or super set delimiter, the process continues to 1010 to read the MSA Group ID field to determine whether or not the AMPDU is destined to the receiving STA based on the group identification as discussed above with respect to FIG. 4. If not, the process continues to 1016 and does not further decode the AMPDU for the currently receiving STA thereby terminating reception of the AMPDU. Alternatively, if the MSA Group ID does match the receiving STA, the process continues to 1018 to read the destination address in the MSA STA ID field of the extended or super set type delimiter. As discussed above with respect to FIG. 4, the MSA STA ID might not be included in some extended delimiters. In such cases, the process may proceed to 1012, as indicated by the dashed line, to read the destination address in the following MPDU header instead. Referring back to decision 1008, if the delimiter is a basic type delimiter, the process continues to 1012 to read the destination address in the header of the subsequent MPDU following the delimiter. Both 1018 and 1012 then continue to decision 1020 to determine if the destination address matches the receiving STA (thereby determining whether or not the MPDU following the delimiter is destined for the receiving STA). If there is a match, the process continues to 1024 to decode the MPDU following the delimiter. The process then proceeds to 1026 to determine if more MPUs are left in the AMPDU by determining if a delimiter follows the MPDU. Additionally, if the process determines (at 1020) that the destination address does not match the STA address, the process skips 1024 and determines (at 1026) if more MPDUs are in the AMPDU. If the process determines that more MPDUs are in the AMPDU, the process moves (at 1022) to the next delimiter in the AMPDU, and then returns to 1006 to read the next delimiter in the AMPDU. If the process determines (at 1026) that no more PDUs are left, then the process ends.

FIG. 11 is a flow chart illustrating an example of various aspects of a method of transmitting a data packet from an AP to a STA as executed by a processing system. This may be performed by software executed by the processor 804B within the processing system 800B discussed above with respect to an AP, or by other means known to one skilled in the art. The process begins at 1102 and continues to 1104 to combine a delimiter before each MPDU. The delimiter type before the first MPDU may be an extended type or super set type delimiter, while the delimiter types before the subsequent MPDUs may be basic delimiters. However, any delimiter type may precede an MPDU. The process then continues to 1106 to combine the MPDU and delimiter pairs into a single aggregate MPDU. The process then continues to 1108 to transmit the aggregate MPDU to all the STAs. Then the process ends. The AMPDU may be broadcast so that multiple STAs are able to detect the transmission but only decode the MPDUs within the AMPDU if they are destined to the STA.

The various aspects of this disclosure are provided to enable one of ordinary skill in the art to practice the present invention. Various modifications to exemplary embodiments presented throughout this disclosure will be readily apparent to those skilled in the art, and the concepts disclosed herein may be extended to other magnetic storage devices. Thus, the claims are not intended to be limited to the various aspects of this disclosure, but are to be accorded the full scope consistent with the language of the claims. All structural and functional equivalents to the various components of the exemplary embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1-26. (canceled)

27. An apparatus comprising:
a processing system configured to:
receive an aggregate data packet comprising a plurality of data packets, each having an address, and a plurality of delimiters, wherein a delimiter precedes each data packet, wherein at least one of the data packets is addressed to a remote apparatus, and wherein at least one delimiter comprises a group identifier indicating whether at least one data packet is addressed to the apparatus; and
process the aggregate data packet if the group identifier indicates that at least one data packet is addressed to the apparatus by processing the data packets addressed to the apparatus.

28. The apparatus of claim 27, wherein the plurality of data packets each comprises a header which includes the address, wherein the processing system is further configured to compare the address in the header of each of the plurality of data packets to an address of the apparatus, and if the addresses match for a data packet, process the data packet.

29. The apparatus of claim 28, wherein the processing system is further configured to drop a data packet if the address for the data packet does not match the address of the apparatus.

30. The apparatus of claim 27, wherein each of the delimiters indicates a length of the subsequent data packet in the aggregate data packet.

31. The apparatus of claim 27, wherein at least one of the delimiters indicates a location within the aggregate data packet for each of the data packets addressed to the apparatus.

32. The apparatus of claim 27, wherein at least one of the delimiters further comprises a scheduled time for the transmission of an acknowledgement for each of the data packets, and wherein the processing system is further configured to transmit the acknowledgement at the scheduled time for each of the data packets in the aggregate data packet that is addressed to the apparatus.

33. The apparatus of claim 27, wherein at least one delimiter comprises a destination address, and wherein the apparatus determines whether to process the aggregate data packet using the address comprised in the delimiter or the address comprised in the subsequent data packet.

34. A method of wireless communication at an apparatus, comprising:
receiving an aggregate data packet comprising a plurality of data packets, each having an address, and a plurality of delimiters, wherein a delimiter precedes each data packet, wherein at least one of the data packets is addressed to a remote apparatus, and wherein at least one delimiter comprises a group identifier indicating whether at least one data packet is addressed to the apparatus; and
processing the aggregate data packet if the group identifier indicates that at least one data packet in the aggregate data packet is addressed to the apparatus by processing the data packets addressed to the apparatus.

35. The method of claim 34, wherein the plurality of data packets each comprises a header which includes the address, the method further comprising:
comparing the address in the header of each data packet to an address of the apparatus, and
processing a data packet if the address in the data packet matches the address of the apparatus.

36. The method of claim 35, further comprising dropping the data packets having an address in the header not matching the address of the apparatus.

37. The method of claim 34, wherein each of the delimiters indicates a length of a subsequent data packet in the aggregate data packet.

38. The method of claim 34, wherein at least one of the delimiters indicates a location within the aggregate data packet for each of the data packets addressed to the apparatus.

39. The method of claim 34, wherein at least one of the delimiters further comprises a scheduled time for the transmission of an acknowledgement for each of the data packets, the method further comprising transmitting the acknowledgement at the scheduled time for each of the data packets in the aggregate data packet that is addressed to the apparatus.

40. The method of claim 34, wherein at least one delimiter comprises a destination address, and wherein the apparatus determines whether to process the aggregate data packet using the address comprised in the delimiter or the address comprised in the subsequent data packet.

41. An apparatus for wireless communications, comprising:
receiving means for receiving an aggregate data packet comprising a plurality of data packets, each having an address, and a plurality of delimiters each preceding each data packet, wherein at least one of the data packets is addressed to a remote apparatus, and wherein at least one delimiter comprises a group identifier indicating whether at least one data packet is addressed to the apparatus; and
processing means for processing the aggregate data packet when the group identifier indicates that at least one data packet is addressed to the apparatus by processing the data packets addressed to the apparatus.

42. The apparatus of claim 41, wherein the plurality of data packets each comprises a header which includes the address, the apparatus further comprising comparing means for comparing the address in the header of each data packet to an address of the apparatus, and wherein the processing means processes the data packets with the address matching the address of the apparatus.

43. The apparatus of claim 42, further comprising dropping means for dropping the data packets with the address not matching the address of the apparatus.

44. The apparatus of claim 41, wherein each of the delimiters indicates a length of the subsequent data packet in the aggregate data packet.

45. The apparatus of claim 41, wherein at least one of the delimiters indicates a location within the aggregate data packet for each of the data packets addressed to the apparatus.

46. The apparatus of claim 41, wherein at least one of the delimiters further comprises a scheduled time for the transmission of an acknowledgement for each of the data packets, the apparatus further comprising transmitting means for transmitting the acknowledgement at the scheduled time for each of the data packets in the aggregate data packet that is addressed to the apparatus.

47. The apparatus of claim 41, wherein at least one delimiter comprises a destination address, and wherein the apparatus determines whether to process the aggregate data packet using the address comprised in the delimiter or the address comprised in the subsequent data packet.

48. A computer program product for an apparatus configured for wireless communication with a transceiver, comprising:
a non-transitory computer-readable medium comprising code executable by one or more processors for:
receiving an aggregate data packet comprising a plurality of data packets, each having an address, and a plurality of delimiters, wherein a delimiter precedes each data packet, wherein at least one of the data packets is addressed to a remote apparatus, and wherein at least one delimiter comprises a group identifier indicating whether at least one data packet is addressed to the apparatus; and
processing the aggregate data packet when the group identifier indicates that at least one data packet in the aggregate data packet is addressed to the apparatus by processing the data packets addressed to the apparatus.

49. The computer program product of claim 48, wherein the plurality of data packets each comprises a header which includes the address, the computer-readable medium further comprising code for:
comparing the address in the header of each data packet to an address of the apparatus, and
processing the data packets with the address in the header matching the address of the apparatus.

50. The computer program product of claim 49, wherein the computer-readable medium further comprises code for dropping a data packet if the address in the header does not match the address of the apparatus.

51. The computer program product of claim 48, wherein each of the delimiters indicates a length of the subsequent data packet in the aggregate data packet.

52. The computer program product of claim 48, wherein at least one delimiter indicates a location within the aggregate data packet for each of the data packets addressed to the apparatus.

53. The computer program product of claim 48, wherein at least one delimiter comprises a destination address, wherein the aggregate data packet is processed by using one of the delimiter address and the subsequent data packet address.
